(19) United States
(12) Patent Application Publication
(10) Pub. No.: US 2024/0394763 A1
(43) Pub. Date: Nov. 28, 2024

(54) REAL-TIME PROCESSING OF BILLING TRANSACTIONS FROM AN ENTERPRISE RESOURCE PLANNING SYSTEM

(71) Applicant: COGNITUS CONSULTING LLC, Dalla, TX (US)

(72) Inventors: Christopher Skinner, Dallas, TX (US); Pavan Thakran, Dallas, TX (US); Pat Sathi, Dallas, TX (US); Rob van der Zande, Dallas, TX (US); Nitin Khanna, Dallas, TX (US)

(73) Assignee: COGNITUS CONSULTING LLC, Dallas, TX (US)

(21) Appl. No.: 18/675,386

(22) Filed: May 28, 2024

Related U.S. Application Data
(60) Provisional application No. 63/469,033, filed on May 25, 2023.

(51) Int. Cl. G06Q 30/04

(52) U.S. Cl. CPC G06Q 30/04

(57) ABSTRACT

Systems and methods are described for processing billing transactions from an Enterprise Resource Planning (“ERP”) system. In an example, when a new transaction posts to an ERP database, the ERP system creates a first virtual table with data related to the transaction. An application queries the ERP's database to create a second virtual table based on the first virtual table based on preconfigured criteria. Using the second virtual table, the application creates an editable billing item with all the data for billing the particular transaction type of the transaction. The editable billing items can be stored until the end of the billing period. At final billing, the application aggregates data from the editable billing items of each transaction type and sends the aggregated data to the ERP system for final billing. Prior to final billing, the editable billing items can be edited or changed as needed.

### BACKGROUND

Enterprise Resource Planning (“ERP”) software is a type of business management software that integrates and automates various business processes such as accounting, inventory management, supply chain management, human resources, customer relationship management, and more. The primary goal of ERP software is to provide a centralized system that enables businesses to streamline their operations, reduce costs, and increase efficiency.

However, ERP platforms, such as System Analysis Program Development (“SAP”), currently struggle to effectively process billing records at scale. For example, ERP platforms typically use resource related billing (“RRB”) methods where all billing data is stored during a billing cycle and then processed all at once at the end of the billing cycle. That time, each line item in the billing data is individually processed. Processing billing records for organizations with a large number of billing records in a billing cycle can take many hours and bog down the system in the meantime. The problem gets worse when the billing records contain more data. For example, organizations that have government contracts are subject to intense auditing procedures. As a result, their billing records are highly detailed and take even longer to process. As an example, processing one million records (the limit in some ERP platforms) can take over thirty hours to process.

The problem is compounded when any reprocessing is required. This occurs frequently, for example, when a provisional pricing rate differs from a later finalized rate. ERP platforms do not have a way of identifying only the records that need a pricing modification. Instead, all the billing data from the previous billing cycles (going back to the start of the provisional rate) must be completely reprocessed. This wastes computing resources for performing duplicative operations.

As a result, a need exists for an efficient method for processing transactions from an ERP platform.

### SUMMARY

Examples described herein include systems and methods for processing ERP transaction records. The embodiments disclosed herein overcome the challenges described in the prior art, such as RRB-related methods, by improving computer systems, including making the computer systems more efficient, increasing processing capabilities, and eliminating wasted computer resources. A real-time billing (“RTB”) application is introduced that can process ERP transaction records in real time. In an example, when a new transaction is posted at an ERP database, the ERP system can notify the RTB application. The RTB application can allow users to configure trigger events for processing transactions of various transaction types. Some examples of trigger events include in real-time, as part of a scheduled job, or manually. The embodiments described herein refer to billing transactions when describing transaction records. Some examples of billing transactions can include cost postings, statistical key figure allocations, completion confirmations, goods receipts, and so on. However, these are merely examples and not meant to be limiting in any way. For example, a transaction record can be any type of record, entry, or posting in an ERP database or another database with a similar database structure.

When the RTB application receives the notification from the ERP system that a new transaction has posted, the RTB application can determine the transaction type and match the transaction type to an RTB profile. RTB profiles can indicate which trigger event applies to the transaction type.

In an example, when a new transaction is posted to the ERP system, the ERP system can generate a virtual table (i.e., a database view) with data from the transaction. The ERP system makes this virtual table available to the client as a data dictionary object in an ERP database. The ERP system can then notify the client that a new transaction has posted. As used herein, the term “data view” refers to the type of a virtual table, or view, described above that is created from the ERP database. The data view can be created by joining data from multiple data tables, such as data specific to a client associated with the transaction. As an example, a user can create a project in the RTB application (or, alternatively, directly in the ERP system). Data related to the project can be stored in the ERP database as a data dictionary object. When transactions related to the project are uploaded to the ERP system, the ERP system creates a data view by joining data from the project data dictionary object and the data specific to the transaction.

In response to a trigger event, the RTB application can query the ERP database to create a second virtual table based on the data view. This second virtual table is referred to hereinafter as a “source view.” The data included in the source view is defined in the RTB profile of the transaction type. For example, the RTB application can include a graphical user interface (“GUI”) where a user can configure RTB profiles for transaction types. An RTB profile can include billing configuration criteria for a particular transaction type with respect to a particular client. After an RTB profile is configured, the RTB application executes a code generator that generates a script for creating a source view for the transaction type. When a corresponding trigger event occurs, the RTB application queries the ERP database using the script to generate the source view from the data view. In some examples, the source view can be created by joining data from multiple data views.

The RTB application can then create an editable billing item from the source view. The editable billing item can be a data file, such as a data table, that includes data require for billing the transaction as well as a log of any changes made to the transaction prior to final billing. The RTB application can include a GUI where users can review, modify, or add editable billing items. Also, if a transaction is posted to the ERP database that designates a change to an existing transaction, such as a price or quantity change, then the RTB application can identify the corresponding editable billing items and add subitems, such as an additional row or field in a table, with the changes. The subitems remain in the editable billing item file for auditing purposes. In an example, when a user modifies an editable billing item, the RTB application updates the corresponding source view accordingly.

The RTB application can allow users to designate trigger events for when processing of posted transactions should occur. For example, posted transactions can be set to process in real-time, as part of a scheduled job, or manually. The ERP system can notify the RTB application whenever a new transaction posts for a project. The RTB application can look up the RTB profile of the transaction type to determine whether and when to process the transactions. Processing transactions in real-time has an advantage of distributing the required processing over the span of the billing period rather than doing so all at once at the end. It also allows users to review and make any necessary changes as the transactions are posted, rather than doing them all at once at the end of the billing period. These advantages also apply to non-billing transaction types. For example, real-time processing using the methods described herein distributes processing of the transaction records of any type over the span of any given processing time period.

When transactions for the project are ready for billing, such as at the end of a billing cycle or end of the project, then the RTB application creates billing document requests based on the editable billing items and sends the billing document requests to the ERP system for final billing. The RTB application can create billing document requests by generating a third database view from one or more source views, which is referred to hereinafter as an “aggregation view.” Like the source view, the aggregation view can also be generated based on configuration criteria set by a user from a GUI of the RTB application. The aggregation view can be defined in the RTB profile of the transaction type. The aggregation view can simplify contents of the source view by eliminating characteristic and key figure fields that are not needed for invoice presentation. The RTB application can also perform configured mathematical operations on any remaining key figure fields for the aggregation view. For example, when there are multiple transactions for a particular transaction type, the RTB application can perform mathematical operations to combine those transactions for the invoice. As an example, the RTB application can add all the posted labor hours for a particular labor type and multiply the total labor hours by the corresponding labor rate to get the total labor cost for that labor type. These totals can be inserted into the aggregation view and then converted to the billing document request.

The examples summarized above can each be incorporated into a non-transitory, computer-readable medium having instructions that, when executed by a processor associated with a computing device, cause the processor to perform the stages described. Additionally, the example methods summarized above can each be implemented in a system including, for example, a memory storage and a computing device having a processor that executes instructions to carry out the stages described.

Both the foregoing general description and the following detailed description are exemplary and explanatory only and are not restrictive of the examples, as claimed.

### BRIEF DESCRIPTION OF THE DRAWINGS

FIG. 1 is a flowchart of an example method for processing ERP billing transactions.

FIG. 2 is another flowchart of an example method for processing ERP billing transactions.

FIG. 3 is an illustration of an example system for processing ERP billing transactions.

### DESCRIPTION OF THE EXAMPLES

Reference will now be made in detail to the present examples, including examples illustrated in the accompanying drawings. Wherever possible, the same reference numbers will be used throughout the drawings to refer to the same or like parts.

Systems and methods are described for processing billing transactions from an ERP system. When a new transaction posts to an ERP database, the ERP creates a data view for the transaction. An RTB application directly queries the ERP's database and to create a source view from the data view. The application creates an editable billing item from the source view, which with contains all the data for billing the particular transaction type of the transaction. The editable billing items are be stored until the end of the billing period, at which point the RTB application creates aggregations views, which contain data from all the editable billing items of a corresponding transaction type. The RTB application creates billing document requests from the aggregation views and sends the billing document requests to the ERP system for final billing. Prior to final billing, the editable billing items can be edited or changed as needed in a GUI of the RTB application. For example, if an update to a transaction type is posted to the ERP database, such as a price change, the RTB application can identify and update all corresponding editable billing items automatically.

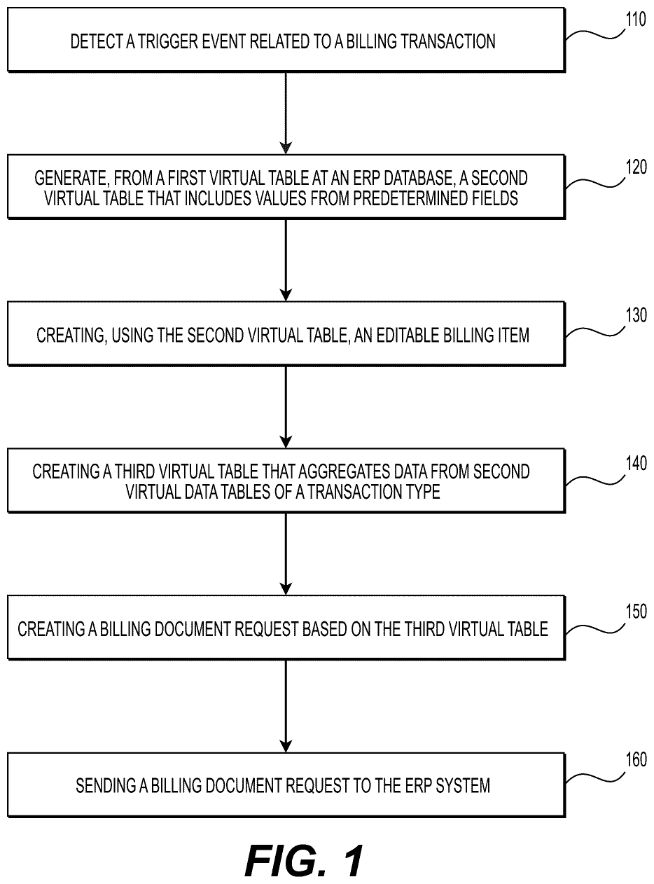

FIG. 1 is a flowchart of an example method for processing ERP billing transactions. At stage 110, an RTB application can detect a trigger event related to a transaction record. This can include, for example, a new billing transaction entry for a project being added to a database layer of an ERP application. As described previously, billing transactions are used throughout this document as an example transaction record type. References made herein to billing transactions are merely exemplary and intended to help illustrate the present invention and to demonstrate its advantages. These references are not meant to be limiting in any way. For example, a transaction record can be any type of record, entry, or posting in an ERP database or another database with a similar database structure.

Some examples of billing transactions can include cost postings, statistical key figure allocations, completion confirmations, goods receipts, and so on. For example, the transaction can be a cost posting that is stored in a database of the ERP system. Cost postings can be records of transactions or events that result in a financial impact, such as expenses. These postings serve as a record of the costs associated with a particular activity or transaction, such as a work-breakdown structure (“WBS”) element, sales document item (“SDI”), network activity, production order, or service order.

A trigger event can be any event that causes the RTB application to process one or more billing transactions. As some examples, a trigger event can be on-demand, in batch, or in real-time. On-demand can be any kind of manual call made by a user. For example, a GUI of the ERP application (or RTB application) can allow a user to manually call the RTB application to process any billing transactions that have not already been processed using other triggering events. On-demand trigger events can be useful in scenarios where, for example, manual review of transaction data is required, such as when a user must review and accept billing terms. For a scheduled job, the RTB application can process new billing transactions at regularly scheduled times or intervals. For real-time, the RTB application can process billing transactions after any specified event occurs, such as a designated process exiting that results in a billable event, such as a timesheet posting or completion of a milestone. For real-time, the RTB application can process the transaction immediately by performing the stages described below.

At stage 120, the RTB application can generate a source view that includes content of the transaction. The source view can be a virtual table, which is a data table that is built on top of an existing table. The source view can be created by joining data from one or more views at the ERP database. For example, when a new transaction posts to the ERP database, the ERP database can create a data view of the transaction. The data view can include data related to the posted transaction, the associated project, and any other relevant data. The ERP can store the data view as a data dictionary object. The RTB application source view query can be run directly on the data view data dictionary object, which can expedite processing time because the ERP database only executes the script on a select few data dictionary objects. For example, some ERP systems include a data modeling infrastructure where data models are defined and consumed on the database rather than on the application server. For example, SAP's High-performance Analytic Application (“HANA”) is an in-memory, column-oriented, relational database management system that runs on database servers and retrieves data as requested by the applications. HANA provides ready-to-use content using a data modeling infrastructure referred to as core data services (“CDS”). CDS provides a Data Definition Language (“DDL”) for defining semantically rich database tables/views. The RTB application can take advantage of this type of data modeling infrastructure to access data and create data models at the database layer rather than the application layer.

For simplicity, the term “CDS” is used throughout this application to describe any data modeling infrastructure that allows data models to be defined and consumed on the database rather than on the application server. For example, CDS can also refer to a data modeling infrastructure that uses Structured Query Language (“SQL”) rather than the DDL provided by CDS. Likewise, references to “CDS views” can include any kind of virtual table, such as a view created by an SQL query. The “views” described herein, such as the data view, source view, and aggregation view, can be CDS views.

In an example, when the ERP system receives transaction data for a data file for a transaction, the ERP system can parse the data and create a record of it at the database layer. The record can include any information identifiable by the ERP system. The RTB application can generate the data view by querying the ERP database for certain content of the transaction. Some examples of such content can include a client name, a client identifier (“ID”), a ledger number, fiscal year, a document number, a document item, a labor rate, recorded labor hours, a material price, a material quantity, and so on.

The RTB application can include a GUI that allows users to configure selection criteria for the source view and the aggregation view discussed later herein. For example, using the RTB GUI, a user can select which data should be included in a data view. The RTB application can include a code generator that automatically generates a code or script for creating a CDS view based on the selection criteria. For example, the code generator can automatically generate a script using the appropriate DDL that queries all the selected data. When a trigger event occurs, the RTB application can run the script to create the CDS view.

The data view can include any information that could potentially be needed for billing. The data view can support multiple billing methods. For example, when generating the data view, the RTB application can query information relevant to both cost plus type billing and materials type billing. As a result, the data view will contain all the information needed for billing, regardless of the billing type.

For some transactions, the RTB application can add any applicable material determination tables to the data view. Material determination enables automatic substitutions of materials in sales documents. The RTB application can add the material determination data by inserting a reference to another table that has the material determination data of the client.

The content included in a source view can be specific to the transaction type. For example, the RTB application can use one script for generating a source view for labor hours and different script for cost of materials. The data view has all the necessary information, regardless of the transaction type, so the source view is generated directly from the data view.

In one example, the content included in the source view can be based on an RTB profile for the corresponding transaction type. An RTB profile can include billing configuration criteria for a particular transaction type with respect to a particular client. For example, an RTB profile can designate which data fields to pull from the data view into the source view, map the data fields from the source view to fields in a corresponding contract (e.g., WBS billing element or SDI), identify a billing document type that the billing record corresponds to, and designate rule sets for aggregation, contract changes, and material determination.

In one example, the RTB profile can be a set of data tables in a hierarchal structure that reference each other. For example, Table 1 below is an example of an RTB profile header template.

TABLE 1

| Field | Data Type/Length | Notes |
|---|---|---|
| MANDT | CHAR(3) | ERP Client |
| /CGDC/RTBPROFILE | CHAR(8) | RTB Profile Key |
| KTEXT | CHAR(40) | RTB Profile Name |
| RELTYPE | CHAR(2) | Relationship Type - |
| | | Domain Values: |
| | | WB - WBS Billing |
| | | Element |
| | | SI - Sales Document Item |
| CONTRACT_RULE | CHAR(4) | Contract Change |
| | | Checking Rule - Check |
| | | against table |
| | | /CGDC/T_CTRCCHRL- |
| | | CONTRACT_RULE |
| MATDET_RULE | CHAR(4) | Material Determination |
| | | Rule - Check against |
| | | table |
| | | /CGDC/T_MATDETRL- |
| | | MATDET_RULE |
| BDR_TYPE | CHAR(4) | BDR Type - check |
| | | against TVFK-FKART |
| | | where VBTYP = ‘EBDR’ |
| STATUS | CHAR(1) | Profile Status - Domain |
| | | Values: |
| | | ‘D’ - Draft |
| | | ‘A’ - Active |
| | | ‘X’ - Deactivated |

In Table 1, the “Field” column includes the name of the corresponding setting, the “Data Type/Length” column indicates the data type of the setting and the maximum or required length of the value. The “Notes” column describes the value that should be included in the row for the corresponding setting. For example, the “MANDT” field is a client ID that is three characters long. The “/CGDC/RTBPROFILE” setting is an RTB profile ID that is unique to the RTB profile. The “KTEXT” field is the name of the client. The “RELTYPE” field for an RTB profile indicates the type of billing contract that the billing record maps to. The “CONTRACT_RULE” field points to another table in the RTB profile that includes a set of rules based on contract changes for the client that occurred during the billing period. The table with contract changes can be updated whenever a change occurs, such as when the actual cost of labor or materials changes from a preliminary agreement cost. The “MATDET_RULE” field points to a table for the RTB profile that includes material definition rules for the client. The “BDR_TYPE” field indicates a BDR type. The “STATUS” field indicates whether the RTB profile is active.

Table 2 below is an example RTB profile data source template that identifies data sources.

TABLE 2

| Field | Data Type/Length | Notes |
|---|---|---|
| MANDT | CHAR(3) | SAP Client |
| /CGDC/RTBPROFILE | CHAR(8) | RTB Profile Key |
| SOURCE_VIEW | CHAR(24) | Source CDS View |
| SOURCE_ROW | NUMC(4) | Source Row |
| AGGREG_VIEW | CHAR(24) | Aggregation CDS View |

The first two rows of Table 2, “MANDT” and “/CGDC/RTBPROFILE”, have the same values as the first two rows of Table 1. These fields can be used to group the tables for a particular RTB profile. The “SOURCE_VIEW” field includes a reference to the data view that has the data for the source view. The “SOURCE_ROW” indicates which row of the data view to pull the data from. When applicable, the “AGGREG_VIEW” identifies an aggregation CDS view to use when performing aggregation.

Table 3 below is an example RTB profile trigger template that identifies trigger events for processing corresponding transaction types.

TABLE 3

| Field | Data Type/Length | Notes |
|---|---|---|
| MANDT | CHAR(3) | SAP Client |
| TRANSACTIONTYPE | CHAR(4) | Transaction Type |
| TRIGGERTYPE | CHAR(1) | Trigger Type-Domain |
| | | Value Range: |
| | | R - Real-Time |
| | | F - Follow-Up Batch Job |
| | | S - Scheduled Batch Job |
| | | M - Manual Only |
| DATASOURCE | CHAR(12) | Data Source CDS View |
| PREC_BATCH_JOB | CHAR(12) | Preceding Batch Job |

The “TRANSACTIONTYPE” field includes a designation of the transaction type. The “TRIGGERTYPE” field includes a value that corresponds to one of multiple triggers types to apply to the transaction type. For example, the TRIGGERTYPE field for an RTB profile can include an “R” for processing in real-time, an “F” for processing as a follow-up batch job, an “S” for processing as a scheduled batch job, or an “M” for manual processing based on user input. The “DATASOURCE” field can indicate the data source for creating the CDS views, such as which database the transactions are stored at. The “PREC_BATCH_JOB” indicates any preceding batch job that runs, which can help identify which transaction need to be processed.

After creating a data view of a transaction, the RTB application can use data in the data view to identify the corresponding RTB profile header. For example, the RTB application can match the client name or ID and transaction type to a corresponding RTB profile. Then, the RTB application can locate and run the script in the RTB profile to generate the source view.

At stage 130, the RTB application can create, using the source view, an editable billing item. The editable billing item can be an editable document that includes any information from the source view that may be relevant for creating a finalized billing document. Billing documents generated within an ERP system are generally non-editable and must be used for billing or rejected entirely. Furthermore, ERP systems generate billing documents at the end of the billing period, and any changes therefore require reprocessing. The editable billing itemeditable billing item, which is created in response to any trigger event, allows for edits to be made prior to the creation of a billing document.

The editable billing item can be populated using data from the source view. For example, the RTB application can populate the editable billing item by copying rows from the source view to a table using a move-corresponding statement. The source view can include field mapping for determining which target field in the editable billing item should be filled for each field in the source view.

In an example, the RTB application can include a GUI for editing editable billing items. In one example, this GUI can be an interface for a sub-application within the ERP application. For example, FIORI is a platform provided by SAP that allows clients to build modern and user-friendly enterprise applications. Fiori applications are typically built on top of SAP's underlying technology stack, such as SAP User Interface for Hypertext Markup Language 5 (“HTML5”) (“SAPUI5”), which is a JavaScript framework for building web applications.

In the GUI, a user can change characteristic fields such as partner assignment, description, and so on. For characteristic changes, the application described above (referred to hereinafter as the “billing calculation application”) can simply update the editable billing item. The user can also change key figures in the form of postponement, rejection, or manual edits to item values. For key figure changes, the billing calculation application can record the change as a sub-item. This can provide an easily traceable record of key figure changes for auditing purposes. Some examples of key figure changes can include changes to quantity, cost, and price.

The billing calculation application can allow users to postpone the billing of all or portions of items in a billing record. For example, if a billing record has a quantity of ten of a certain item, the user can select to postpone billing fewer than ten, such as three. The user can designate a postponement length and provide a basis for the postponement. Two possible bases for postponement are cost and quantity. If the user chooses to postpone on a quantity basis, then the cost corresponding to that quantity is also postponed. For example, if the original quantity is 50 and the original cost is $1,000 United States Dollars (“USD”), then the cost per quantity is $20 USD. If the user postpones a quantity of 3, then a cost of $60 USD is postponed as well. Conversely, the same logic applies if the user postpones on a cost basis. For example, if the user postpones a cost of $70 USD, then a quantity of 3.5 would be postponed as well.

All the postponement information can be added to the editable billing item as subitems so that all the items from the original billing record can be reconciled. In an example, prior to saving any edits to an item affecting cost, quantity, or price, the billing calculation application can execute a self-reconciliation to ensure that the item and all subitems with certain postponement or modification reason codes total to the original quantity and cost of the corresponding source view.

The billing calculation application can allow users to manually add billing items. These items are unique in that they do not have a corresponding entry in any cross-reference table. They can be used, for example, for manual debits and credits. After a manual item is added, it can be treated the same as any other item. For example, it may not be able to be deleted, but it can be rejected or postponed.

In an example, editable billing items can be stored until the end of the billing cycle. This allows for manual review and changes at any time during the billing cycle. Whenever a change is made, rather than reprocessing the entire billing item or reprocessing all billing items at once, the billing calculation application can simply update the editable billing item.

The editable billing item also allows for quicker updates whenever a change occurs that affects multiple billing items. As an example, if the final contracted price changes during the billing cycle from the preliminary contracted price, the price change can be automatically added to the relevant billing items by adding a subitem to the corresponding editable billing items. The billing calculation application can identify the relevant billing items by matching key fields in the change record to corresponding key fields in the editable billing item. For example, the billing calculation application can match fields from the change record to the relevant editable billing item, such as the client name or ID, project or subproject name or ID, material ID, and so on. The billing calculation application can do this as soon as the change record is loaded into the database, as opposed than waiting for the end of the billing cycle. The original records do not require reprocessing. Also, Users can view up-to-date information about all submitted billing items in the billing calculation application. Users do not have to wait until the end of the billing cycle to view this information.

In an example, the source view for a transaction can be saved as a data dictionary object. This data dictionary object can be linked to an editable billing item so that the source view data dictionary object is updated when changes are made to the editable billing item.

At stage 140, the RTB application can create an aggregation view from one or more source views. An aggregation view is a CDS view that simplifies contents of the source view by eliminating characteristic and key figure fields from the source view that are not needed for invoice presentation. The RTB application can generate an aggregation view by querying corresponding source views. Each aggregation view can aggregate the data from source view data dictionary objects corresponding to the same transaction type. For example, one aggregation view can aggregate all the data for labor hours related to plumbing and another aggregation view can aggregate all the quantities and costs of materials for exterior construction material of a project.

Like the source view, the aggregation view can also be generated based on configuration criteria set by a user from a GUI of the RTB application. The aggregation view can be defined in the RTB profile of the transaction type. The RTB application can perform configured mathematical operations on any remaining key figure fields for the aggregation view. For example, when there are multiple transactions for a particular transaction type, the RTB application can perform mathematical operations to combine those transactions for the invoice. As an example, the RTB application can add all the posted labor hours for a particular labor type and multiply the total labor hours by the corresponding labor rate to get the total labor cost for that labor type. These totals can be inserted into the aggregation view and then converted to the billing document request. In another example, a client can submit multiple transactions for the same material during a billing period. When this happens, the RTB application can identify any previously (or concurrently) submitted transactions for the same material (based on), add the quantities together, calculate the total cost, and insert the total quantities and costs to the aggregation view.

In an example, the RTB application can use a designated condition type as a parameter to determine whether to include a transaction in the aggregation view. For example, editable billing items can include a parameter that designates whether the corresponding transaction is ready for billing. If a transaction is ready, then the RTB application can add the data from the corresponding source view data dictionary object to the aggregation view for the transaction type. If a transaction is not marked ready, then the transaction can be omitted. As a result, an aggregation view will include data for all billing transactions of a certain transaction type that are ready for billing. The RTB application can create aggregation views for each transaction type of a project.

At stage 150, the RTB application can create a billing document request based on the aggregation view. Creating a billing document request can include multiple sub-steps. For example, the RTB application can lock the editable billing item header and all relevant billing items. The RTB application can then copy the editable billing item header information into a designated node of the billing document request API. To ensure that previously billed items are not rebilled, the RTB application can cross-reference the billing status of the billing items. The RTB application can then copy data from the aggregation view into corresponding fields of the billing document request API. The RTB application can then update the status of these billing items to reflect that the items have been billed. The RTB application can do this by, as an example, updated the status parameter in the billing item's source view.

At stage 160, the RTB application can send the billing document request to the ERP system for creating an invoice. In an example, this can be done by making an Application Programming Interface (“API”) call to the ERP system. For example, the ERP system can include an API for requesting billing documents. For example, the RTB can send the billing document request as an API call/request to the ERP system, such as the API request described above. The ERP system can then process the request by generating an invoice.

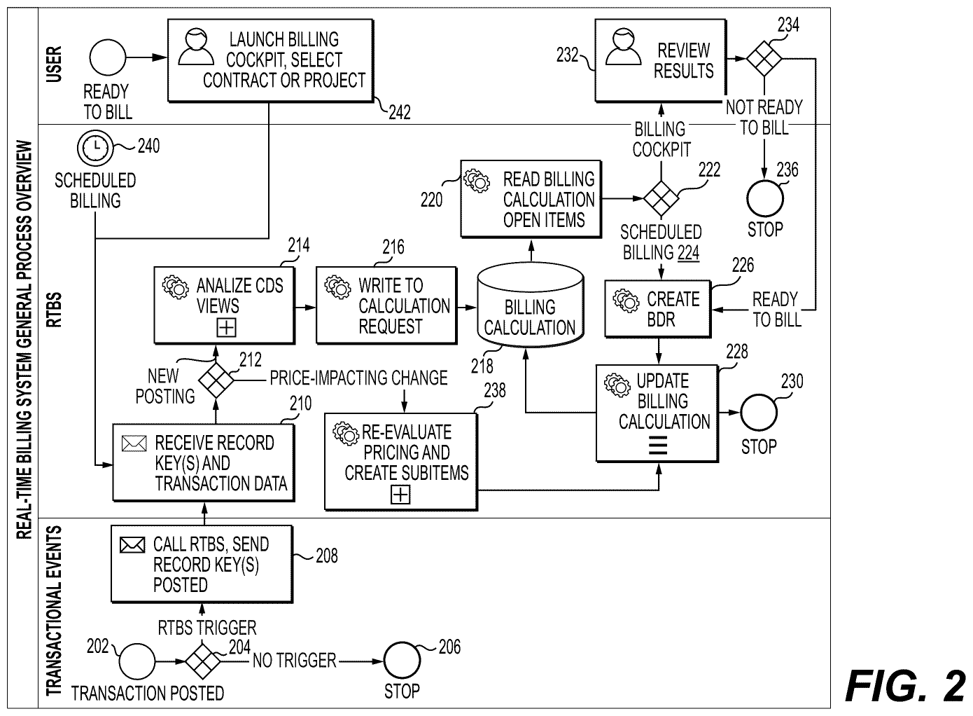

FIG. 2 is another flowchart of an example method for processing ERP billing records. The flowchart of FIG. 2 illustrates three ways that the ERP billing record process can begin. In a first way, beginning at stage 202, a billing record can be processed in real-time after a transaction is posted. In a second way, beginning at stage 240, billing records can be processed as part of a scheduled job. In a third way, beginning at stage 242, a user can manually initiate the processing.

Beginning with real-time processing, at stage 202, a transaction posts to the ERP database. For example, an employee or vendor can upload a document or submit data related to a financial transaction into the ERP system. This can include, for example, a timesheet, a pricing agreement, a materials cost list, and so on. The ERP system can save the transaction data in the ERP database as a data view.

At stage 204, the ERP database manager determines whether the posted transaction should be sent to the RTB application. For example, the ERP database manager can be configured to send certain transaction the RTB application. This can be done using any appropriate parameters. As an example, the ERP database manager can be configured to notify the RTB application whenever transaction associated with a certain client ID or project ID is received. If the transaction is not related to the RTB application, then, at stage 206, the transaction is not processed.

If the transaction is related to the RTB application, then, at stage 208, the ERP database manager calls the RTB application using any predetermined communication protocol, such as an API call. The API call includes the transaction data and a record key generated by the database manager. A record key can be an identifier that uniquely identifies the transaction record in the ERP system.

The RTB application receives the transaction data and record key at stage 210. At this stage, the RTB application can determine whether the transaction has any associated trigger events. For example, the RTB application can determine the type of transaction and use transaction type field mappings to identify a corresponding RTB profile. Within the RTB profile, the RTB application can identify a trigger event type assigned to the transaction type. If the trigger event type is a scheduled job or manual initiation, then the RTB application does not process the transaction.

If the trigger event type is designated real-time, then the RTB application determines whether the transaction is a price-impacting change at stage 212. The RTB application can be configured to process price-impact changes and new transactions separately. If the transaction is not for a price-impact change, then, at stage 214, the RTB application analyzes CDS views of the transaction. As an example, the RTB application identifies a script in the RTB profile for generating a source view. The RTB application runs the script for generating the source view from the data view in the ERP database. The data view includes any information that could potentially be needed for processing the transaction. The data view can support multiple billing methods, such as cost plus type billing and materials type billing. The RTB application runs the script for generating the source view, which includes select data from the data view based on configuration criteria in the RTB profile.

At stage 216, the RTB application create an editable billing item for the transaction using data from the source view. The editable billing item is an editable document that includes any information from the source view that may be relevant for creating a finalized billing document. For example, the RTB application can populate the editable billing item by copying rows from the source view to a table using a move-corresponding statement. The source view can include field mapping for determining which target field in the editable billing item should be filled for each field in the source view.

At stage 218, the RTB application stores the editable billing item. The RTP application can store the editable billing item at any storage device for long-term storage, such as a database server. The editable billing items can include a status field. The status field can indicate, for example, whether the transaction is pending the end of a postponement time period, requires manual review, has already sent for finalized billing, and so on.

Editable billing items can remain in a pending status during the corresponding billing cycle. In a pending status, the editable billing item can be viewed or edited. In an example, editable billing items can be designated as pending (or can be designated with other statuses) using a marker or flag, such as a field code in a corresponding field of the editable billing item. Field mappings in the editable billing item allow the RTB application to update the transaction as needed during the billing cycle. For example, returning to stage 212, if the transaction record includes a price-impact change, such as a change in estimated materials or labor price, then, at stage 238, the RTB application can process the changes on existing editable billing items for corresponding transactions. For example, if the hourly rate changes for labor hours of electrical work being done on a project, the RTB application can use field mappings to identify all corresponding transactions (editable billing items) that are still pending. Rather than reprocess all the transactions, or even reprocessing just the corresponding transactions, the RTB application merely adds subitems to the editable billing items. This is shown at stage 228. These subitems indicate the change in hourly rate. When the transactions are finalized and invoiced at the end of the billing cycle, the RTB application uses the hourly rate indicated in the subitems when calculating the total price of the electrical labor hours. The original hourly rate is still viewable in the editable billing item for auditing purposes.

Returning to stage 220, the RTB application analyzes the editable billing item, and at stage 222 the RTP application, based on the analysis, determines whether manual review is required prior to final billing. Manual review can be triggered in certain circumstances. For example, certain transaction types or transactions missing data from certain fields can trigger manual review. For those transactions that do not require manual review, the editable billing item remains pending until final billing is scheduled at stage 224.

For transaction types configured for real-time billing, the stages described above can occur in real-time. In other words, rather than waiting for the end of the billing period, the RTB application processes posted transactions into editable billing items as soon as they are posted in the ERP database. This distributes the required processing time over the entire billing period, eliminating the type of slowdown caused by RRB billing methods. It also allows for manual review throughout the billing period, thereby reducing time required for review at the end of the billing period and expediting final billing. Furthermore, it allows transactions to be seamlessly updated by updating relevant editable billing items, rather than reprocessing all pending transactions.

Final billing can occur as a scheduled job or based on manual input. During the final billing process, at stage 226, the RTB application creates a billing document request. The billing document request is a request object that contains itemized billing data. A billing document request is a request sent to the ERP system for generating an invoice for a transaction or group of related transactions. The RTB application can create the billing document request by first creating aggregation views for transaction types that are to be billed. The aggregation views are created by executing a script that queries the source views. To ensure that previously billed items are not rebilled, the RTB application cross-references the billing status of the billing items. The billing status can be stored in the source view of a transaction.

Creating a billing document request can include multiple sub-steps. As an example, the RTB application locks the editable billing item header and all relevant billing items. The RTB application then copies the editable billing item header information into a designated node of the billing document request API. The RTB application also copies data from the aggregation view into the API request. The RTB application then updates the status of these billing items to reflect that the items have been billed, which occurs at stage 228.

After the RTB application sends the billing document request to the ERP system, at stage 230, the ERP system creates finalized billing documents of the transactions.

Returning to stage 222, if manual review of the editable billing item is required, the RTB application sends the editable billing item to a calculation request application for manual review at stage 232. The calculation application can be any application with an interface that allows a user to manually review and edit editable billing items. The calculation application can be part of the RTB application or a sub-application that runs in the ERP system, such as a FIORI application in SAP. The a calculation application allows a user make changes to calculation documents, such as by changing pricing, quantities, or other information. A user can also add missing information or manually create new transactions.

At stage 234, if a transaction is not ready for final billing, then the corresponding editable billing item remains in pending status at stage 236. When the transaction is ready for final billing, the method proceeds to stage 226 where the billing request document is created for the corresponding editable billing item.

For scheduled processing, transactions posted at stage 202 remain in the ERP database until a scheduled processing job runs at stage 240. When the job runs, the method proceeds to stage 210 where RTB application retrieves the transaction data for all transactions assigned to process during a scheduled job. The RTB application then processes the transaction data in the same manner described above starting at stage 210. Similarly, for manual processing, transactions posted at stage 202 can remain in the ERP database until a user manually initiates processing using a GUI at stage 242. The RTB application then processes the transaction data in the same manner described above starting at stage 210.

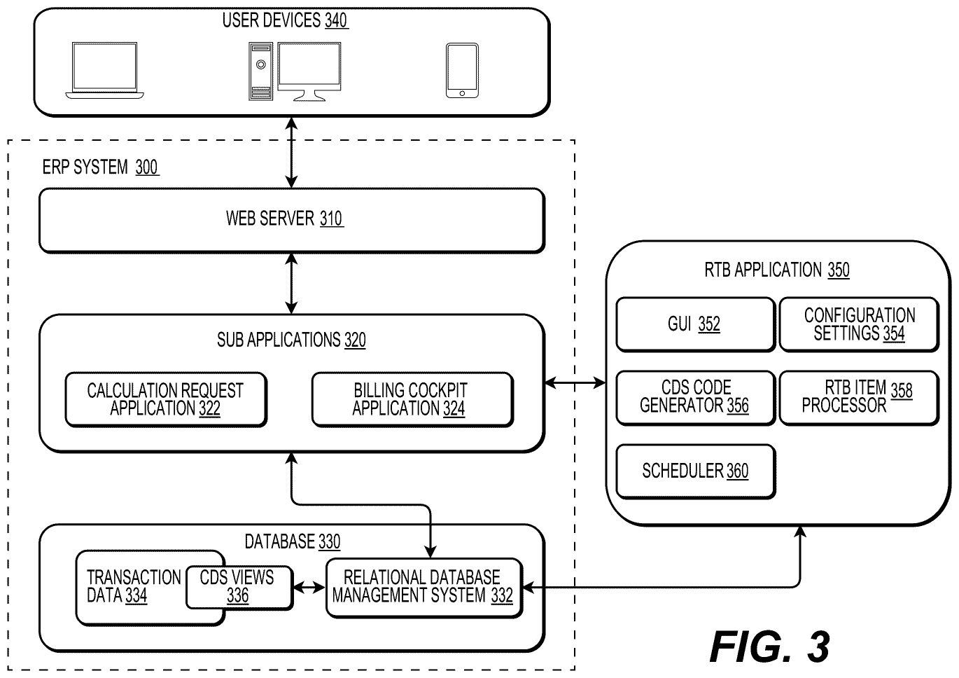

FIG. 3 is an illustration of an example system for processing ERP billing transactions. The example system includes an ERP system 300. The ERP system 300 can be any type of business management software that integrates and automates billing processes. Some examples of ERP systems include SAP, ORACLE NETSUITE, and SAGE INTACT. The ERP system 300 includes a web server 310. The web server 310 can be a single server or a group of servers, including multiple servers implemented virtually across multiple computing platforms. The web server 310 provides user devices 340 with access to the ERP system 300. The user devices 340 can be one or more processor-based devices, such as a personal computer, tablet, or cell phone. The web server 310 and user devices 340 can communicate using any appropriate protocol, such as Hypertext Transfer Protocol Secure (“HTTPS”) or API calls.

The ERP system 300 includes a database 330 where transaction data 334 is stored. The database 330 can be any storage device that can store transactional data and records, such as a database server. The database 330 includes a relational database management system 332 that manages the transaction data 334. The relational database management system 332 includes data modeling infrastructure where data models are defined and consumed on the database rather than on the application server. For example, the relational database management system 332 allows another applications, such as the RTB application 350, to access the transactional data 334 directly at the database layer rather than at an application layer. The relational database management system 332 can allow other applications to access the transaction data 334 using virtual tables, such as CDS views.

The RTB application 350 is a software application that can communicate with the ERP platform to process transaction data 334 into final billing documents. The RTB application 350 includes a GUI 352 where users can create configure settings 354 for RTB profiles, such as the RTB profiles described previously herein. The GUI 352 also allows users to manually trigger processing of transaction posts. A CDS code generator 356 generates scripts for creating CDS views 336 based on the configuration settings 354. An RTB item processor 358 executes the scripts to generate CDS views 336 and converts data from the SDS views into editable billing items. The RTB item processor 358 also creates billing document requests from editable billing items and sends the billing document requests to the ERP system 300 for final billing. The RTB application 350 includes a scheduler 360 that causes the RTB processor 358 to execute at predetermined times.

The RTB application 350 includes one or more sub applications that run in the ERP system 300. For example, in an SAP ERP system, the sub applications can be FIORI applications. A calculation request application 322 provides users with the ability to interact with calculation requests and corresponding items and subitems directly. The calculation request application 322 allows users to review, postpone, reject, edit, and even add manual items such as payment on account entries or miscellaneous credits and debits without having to wait until the end of the billing cycle to do so. This simplifies month-end processes by distributing those tasks over the duration of the month instead of requiring a heavy lift at billing cycle close.

A billing cockpit application 324 proposes billing values of billing items and then provides the user with a rich set of tools to manage those billable items with immediate and meaningful action. The billing cockpit application 324 gives the user the ability to, at any point during a billing cycle, see the current billing value and then carry out the creation of the billing document request. When the billing cockpit application 324 is launched, the RTB item processor 358 beings analyzing CDS views of transactions to ensure the billing data is complete. Then, the user reviews and accepts the billing items for inclusion on a billing document request.

Other examples of the disclosure will be apparent to those skilled in the art from consideration of the specification and practice of the examples disclosed herein. Though some of the described methods have been presented as a series of steps, it should be appreciated that one or more steps can occur simultaneously, in an overlapping fashion, or in a different order. The order of steps presented are only illustrative of the possibilities and those steps can be executed or performed in any suitable fashion. Moreover, the various features of the examples described here are not mutually exclusive. Rather any feature of any example described here can be incorporated into any other suitable example. It is intended that the specification and examples be considered as exemplary only, with a true scope and spirit of the disclosure being indicated by the following claims.

What is claimed is:

1. A method for processing a transaction record from an enterprise resource planning (“ERP”) system, comprising:
detecting a trigger event relating to a transaction record, the trigger event indicating that the transaction record should be processed;
generating, from a first virtual table stored at an ERP database of the ERP system, a second virtual table that includes values from predetermined fields of the first virtual table related to the transaction record;
creating, using the second virtual table, an editable billing item, the editable billing item including price and quantity data from the transaction data;
creating a billing document request based on the editable billing item; and
sending the billing document request to the ERP system.

2. The method of claim 1, wherein the first virtual table is generated in real-time in response to a notification from the ERP system that a transaction of a transaction type posted at the ERP system.

3. The method of claim 1, wherein the editable billing item is created using field mappings included in the second virtual table.

4. The method of claim 1, further comprising:
receiving a modification to the transaction;
identifying the editable billing record corresponding to the transaction; and
adding a subitem to the record, the subitem indicating the modification.

5. The method of claim 1, further comprising:
receiving, through a graphical user interface (“GUI”), an election for postponing a selected portion of the transaction; and
responsive to the election, adding a subitem to the editable billing item that makes the selected portion of the transaction unavailable for final billing for a predetermined amount of time.

6. The method of claim 1, wherein, prior to creating the billing document request, the editable billing item includes a field code indicating that the editable billing item has a pending status, and wherein the editable billing item is viewable and editable in the GUI while has the pending status.

7. The method of claim 6, further comprising:
after creating the billing document, locking the editable billing document; and
changing the field code status to indicate that the editable billing item has a billed status, wherein, while having a billed status, the editable billing item is viewable in the GUI and not editable.

8. The method of claim 1, wherein
the transaction record is of a certain transaction record type, and
creating the billing document request comprises:
creating a third virtual table, the third virtual table including aggregated data from a plurality of second virtual tables, each of the plurality of second virtual tables corresponding to a different transaction record of the transaction record type; and
inserting data from the third virtual table into corresponding fields of a billing document request Application Programming Interface of the ERP system.

9. The method of claim 1, wherein the first virtual table and the second virtual table are created using a database query script created by a code generator based on settings provided at a graphical user interface (“GUI”).

10. The method of claim 1, further comprising:
prior to creating the billing document request, receiving a selection for postponing billing for a portion of a quantity of items from the transaction record;
determining a cost per item based on cost and quantity data in the editable billing item;
calculating a total price of the portion of the quantity of items based on the determined cost per item; and
adding a subitem to the editable billing item that includes the portion of the quantity of items and the determined total price.

11. A non-transitory, computer-readable medium containing instructions that, when executed by a hardware-based processor, causes the processor to perform stages for processing a transaction record from an enterprise resource planning (“ERP”) system, the stages comprising:
detecting a trigger event relating to a billing transaction, the trigger event indicating that the transaction record should be processed;
generating, from a first virtual table stored at an ERP database of the ERP system, a second virtual table that includes values from predetermined fields of the first virtual table related to the transaction record;
creating, using the second virtual table, an editable billing item, the editable billing item including price and quantity data from the transaction data;
creating a billing document request based on the editable billing item; and
sending the billing document request to the ERP system.

12. The non-transitory, computer-readable medium of claim 11, wherein the first virtual table is generated in real-time in response to a notification from the ERP system that a transaction of a transaction type posted at the ERP system.

13. The non-transitory, computer-readable medium of claim 11, wherein the editable billing item is created using field mappings included in the second virtual table.

14. The non-transitory, computer-readable medium of claim 11, the stages further comprising:
receiving a modification to the transaction;
identifying the editable billing record corresponding to the transaction; and
adding a subitem to the record, the subitem indicating the modification.

15. The non-transitory, computer-readable medium of claim 11, the stages further comprising:
receiving, through a graphical user interface (“GUI”), an election for postponing a selected portion of the transaction; and
responsive to the election, adding a subitem to the editable billing item that makes the selected portion of the transaction unavailable for final billing for a predetermined amount of time.

16. The non-transitory, computer-readable medium of claim 11, wherein, prior to creating the billing document request, the editable billing item includes a field code indicating that the editable billing item has a pending status, and wherein the editable billing item is viewable and editable in the GUI while has the pending status.

17. The non-transitory, computer-readable medium of claim 16, the stages further comprising:
after creating the billing document, locking the editable billing document; and
changing the field code status to indicate that the editable billing item has a billed status, wherein, while having a billed status, the editable billing item is viewable in the GUI and not editable.

18. The non-transitory, computer-readable medium of claim 11, wherein
the transaction record is of a certain transaction record type, and
creating the billing document request comprises:
creating a third virtual table, the third virtual table including aggregated data from a plurality of second virtual tables, each of the plurality of second virtual tables corresponding to a different transaction record of the transaction record type; and
inserting data from the third virtual table into corresponding fields of a billing document request Application Programming Interface of the ERP system.

19. The non-transitory, computer-readable medium of claim 11, wherein the first virtual table and the second virtual table are created using a database query script created by a code generator based on settings provided at a graphical user interface (“GUI”).

20. The non-transitory, computer-readable medium of claim 11, the stages further comprising:
prior to creating the billing document request, receiving a selection for postponing billing for a portion of a quantity of items from the transaction record;
determining a cost per item based on cost and quantity data in the editable billing item;
calculating a total price of the portion of the quantity of items based on the determined cost per item; and
adding a subitem to the editable billing item that includes the portion of the quantity of items and the determined total price.
